(19) United States
(12) Patent Application Publication
(10) Pub. No.: US 2006/0071084 A1
(43) Pub. Date: Apr. 6, 2006

(54) Process for manufacture of novel, inexpensive radio frequency identification devices

(75) Inventors: Robert H Detig, New Providence, NJ (US); Vernon L Bremberg, Short Hills, NJ (US)

Correspondence Address: SYNNESTVEDT LECHNER & WOODBRIDGE LLP, P O BOX 592, PRINCETON, NJ, 08542-0592, US

(73) Assignee: ELECTROX CORPORATION, NEW PROVIDENCE, NJ (US)

(21) Appl. No.: 10/539,158

(22) PCT Filed: Dec. 14, 2001
(86) PCT No.: PCT/US01/48253

§ 371 Date: Jun. 14, 2005

Related U.S. Application Data
(60) Provisional application No. 60/255,490, filed on Dec. 15, 2000.

(51) Int. Cl. G06K 19/06; G08B 13/14; H01Q 17/00

(52) U.S. Cl. 235/492; 340/572.8; 29/601

(57) ABSTRACT

A novel process for fabricating low cost RFID devices in which a pattern of metallic toner is printed on a substrate and the contacts on a silicon die are placed directly on contact points printed as part of the pattern of metallic toner; the whole device is then heated to both cure the metallic toner into metallic conductors and bond the silicon die to the metallic conductors. Alternatively, the silicon die can be physically attached to the substrate and the electrical pathway between the silicon die and the metallic conductors is established via a transformer coupling comprised of a coil winding on the silicon die and a pattern of coils printed as part of the metallic toner pattern. The pattern of coils can be comprised of individually printed coil loops printed on, and separated by, dielectric layers.

### CROSS REFERENCE TO RELATED APPLICATIONS

This application claims the priority of U.S. Provisional Patent Application Ser. No. 60/255,490 filed Dec. 15, 2000, the entire contents and subject matter of which is hereby incorporated in total by reference.

### BACKGROUND OF THE INVENTION

1. Field of the Invention

This invention describes methods for the manufacture of inexpensive radio frequency identification devices (RFID) that are also very thin in cross section so that they can be laminated into paper, tags or labels without mechanical interference nor surface distortion.

2. Description of the Related Art

Radio frequency identification and tracking devices (RFID) have shown a rapid growth in both function and capabilities. RFIDs are currently used in everything from anti theft tags, to smart wireless cards to identification tags for merchandise and many other uses are in the design/system specification stage. Examples of currently available systems which use RFID tags for merchandise include Tag-It (Texas Instruments) and “iCode” (by Philips Electronics). With a potential need for billions of such devices, low cost per “tag” and maximum functionality are the goals in the market place.

Current manufacturing utilizes photolithographic methods which are costly, time consuming and can be environmentally hazardous.

While researchers are describing ways to “print” organic transistors or nano-particle inorganic transistors for RFID; their performance levels are not up to the speeds required for high frequency radio frequency devices. RFID band-width assignments are expected to be in the 800 to 950 MHz range. Therefore standard silicon chips with very high performance (which are capable of functioning in the desired frequency range) and at relatively little cost need to be mounted and electrically connected to an inexpensive printed wiring structure. Current methods for mounting the silicon chips, such as “flip-chip” methodology, require equipment for precise alignment of the chip and can also be time consuming.

### SUMMARY OF THE INVENTION

This invention relates to a process for the manufacture of inexpensive RFID devices that are mechanically, very thin in dimension and are inexpensive to manufacture because of unique techniques used to produce the metallic wiring structure and to interconnect the silicon devices to the metallic wiring structure. A metallic toner is printed on the substrate in the desired pattern. A thin silicon wafer is placed active side down on the unsintered metal toner printed pattern, then the whole structure is heated to a temperature suitable for the substrate (for example, for a PET substrate 125° C. for approximately 2 minutes) sintering the metal toner and bonding the metal to the electrode pads on the silicon chip.

In an alternate method of connecting the chip to the substrate, the chip itself contains on its top, active surface a coil of printed metal that serves as the primary of an air core transformer. The chip is mechanically bonded by a suitable adhesive, in close proximity to a secondary transformer winding printed on the printed wiring structure of the “tag” device.

### BRIEF DESCRIPTION OF THE DRAWINGS

FIG. 1 shows an electrical schematic of a preferred embodiment of the invention.

FIG. 2 shows a schematic of an alternate embodiment of the invention.

FIG. 3 shows the wiring layout of a preferred embodiment.

FIG. 4 shows a cross section of the embodiment of FIG. 3.

FIG. 5 shows the wiring pattern for an alternate embodiment of the invention with a transformer coil.

FIG. 6 shows a detail of the multi layer patterns of the transformer coil of FIG. 5.

FIG. 7 shows a cross section of an alternate embodiment with a transformer coupling.

### DETAILED DESCRIPTION OF THE INVENTION

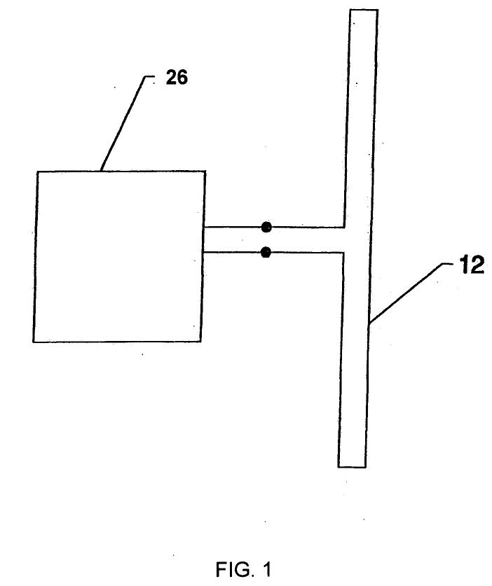

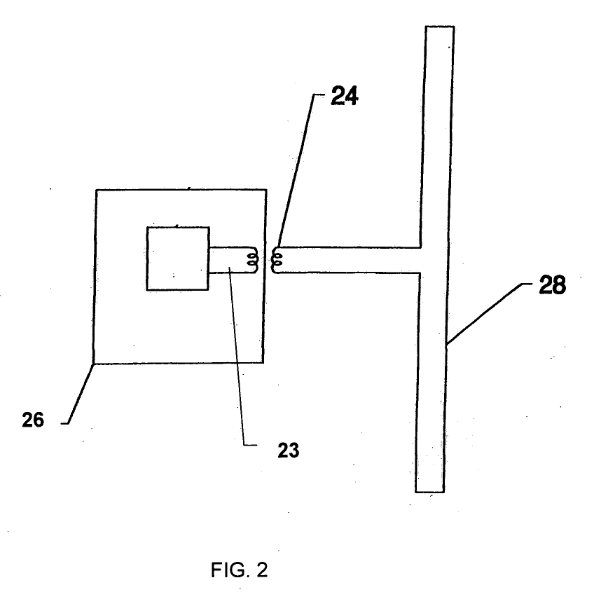

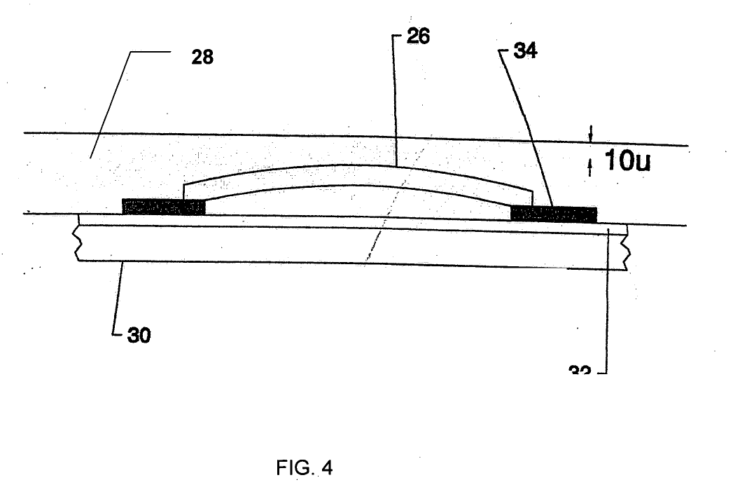

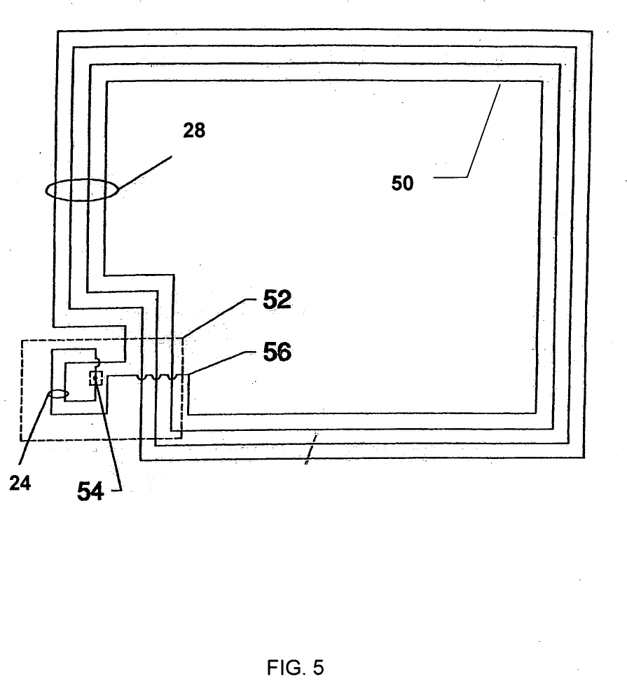

FIG. 1 shows a schematic of a preferred embodiment of the invention. A silicon chip 10 is connected by two pads to loop antenna 12 printed on the tag substrate. FIG. 3 shows a layout of the “tag” made by the process of the alternate embodiment. The loop antenna consists of two or more turns of metal pattern 20 ending in two pads 22 across which is mounted a Si chip 26 active side down (i.e., the bonding pads on the chip touch pads 22). FIG. 4 shows a cross section of a preferred embodiment of the invention. Substrate 30 is the mechanical carrier or support. It preferably is not metal as this would raise losses in the reception and transmission of r.f. energy. Typical substrates that are inexpensive are PET film, PEN film, paper, glass epoxy and the like. If PET is used, an anti-static layer can be used to enhance the electrostatic transfer of metal toner to its surface. If paper is used, an adhesion layer is preferably used to fill the pores and fiber cavities of the paper and provide adhesion for the metallic toner particles to the substrate. In either case the adhesion layer preferably includes a resin to promote low temperature processing of the silver toner into a solid metal conductor. A typical and preferred resin is selected from the DOW chemical series of Saran™ resins though other resins have worked well.

On top of the anti-stat/adhesion layer, conductor patterns are printed by means of electrostatic printing of metal toners on the anti-stat surface. Typical metal toners include copper, silver, aluminum and gold, with silver being a preferred toner. After drying of the liquid toner hydrocarbon diluent, the metal toner is sintered by heating to a temperature compatible with the upper temperature limit of the substrate. In one embodiment, after drying the toner, the silicon chip 26 is placed on the dried powder silver toner, bonding pads down onto the silver toner pattern. Now the entire assembly is sintered whereby the silver particles sinter into a solid mass and sinter themselves to the bonding pads of the chip. Thus the metal traces are sintered and the silicon chip is bonded to the pads in a single step. This achieves a significant cost advantage over other production methods.

Finally a liquid resin encapsulation layer, 28, is applied to act as a vapor and oxygen barrier. The layer can be applied by various means; spray, liquid roll, silk screening, etc. and cured appropriately to complete the final product. Preferred resins include Saran® and epoxy resins.

In summary, the manufacturing steps are:
1. Print pattern of metal toner;
2. Dry diluent from/off of toner;
3. Mechanically place silicon chip/die;
4. Sinter the structure;
5. Overcoat or encapsulate with liquid resin;
6. Drying or cross-linking of the overcoat resin.

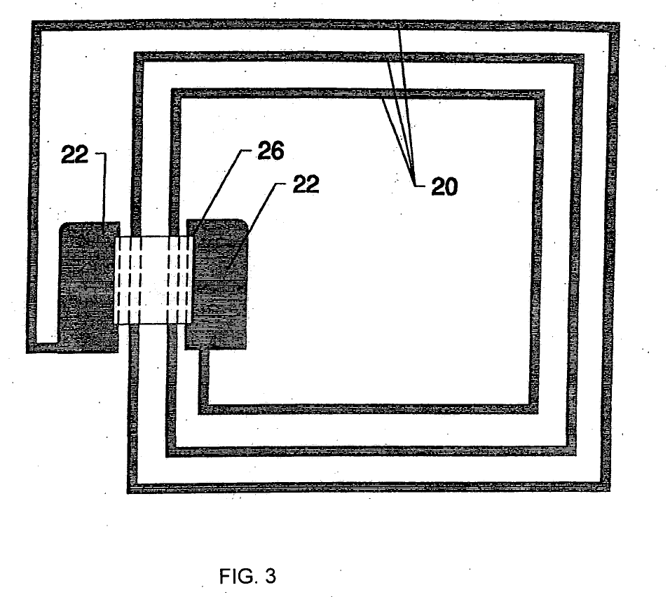

FIG. 2 illustrates a tag utilizing the transformer coupling aspect of the invention. In the device of FIG. 5 a typical 4 turn antenna loop 50 having two end points 54, 56 is printed on the edges of the “tag”. A clear dielectric cross over layer 52 is placed over the section of the tag where the end points 54, 56 are located. This allows for subsequent layer of patterned metal toner to be printed on the cross-over layer without making electrical contact with the underlying toner pattern 50. The area of the dielectric layer above the end points 54, 56 is either removed or is not placed with the rest of the dielectric layer, to enable an electrical connection to the end points 54, 56. Now a second layer of metal 58 in the form of one or more loops having end points located directly above, and so connected to end points 54 and 56 is placed on the dielectric layer thereby completing the circuit and forming a winding for an air core transformer. In summary, the three layers; a first layer of metal 50, dielectric layer 52, and top metal layer 58 make an electrically continuous loop consisting of a large area antenna, 50, 28 and a transformer winding, 58, 26.

Additional dielectric layers and metal layers can be added to form multi layered circuits.

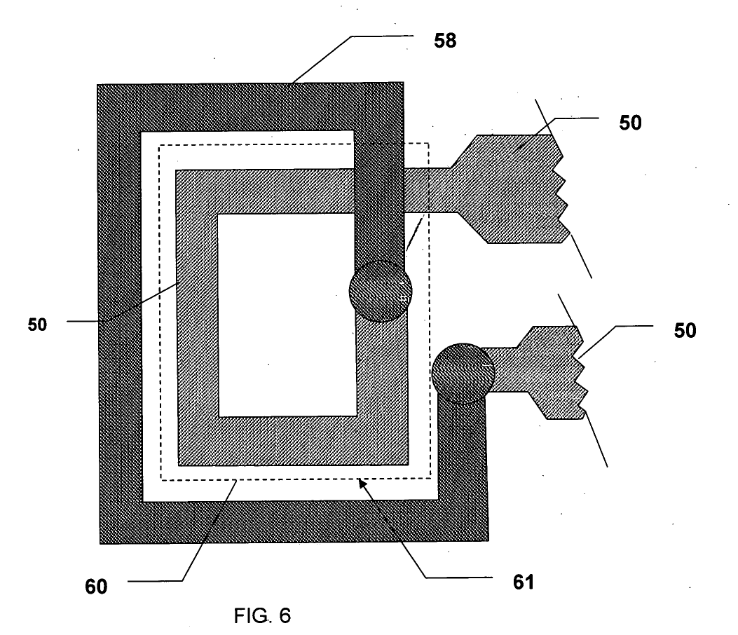

FIG. 6 shows the 2nd layer metal co-located over a segment of the 1 st layer metal to form the coil. To complete the transformer coupling with the silicon chip the chip contains a output transformer coil 24 and is mounted directly above the coil 50, 28, 58, 26 on the substrate. While the location of the chip is not as critical as when mounting and physically and electrically connecting the chip to the metal toner circuit, it is preferred, to increase efficiency of signal/power transfer, to place the chip as close to the substrate coil as possible, for example, within the locations X-X, 60 and Y-Y 62.

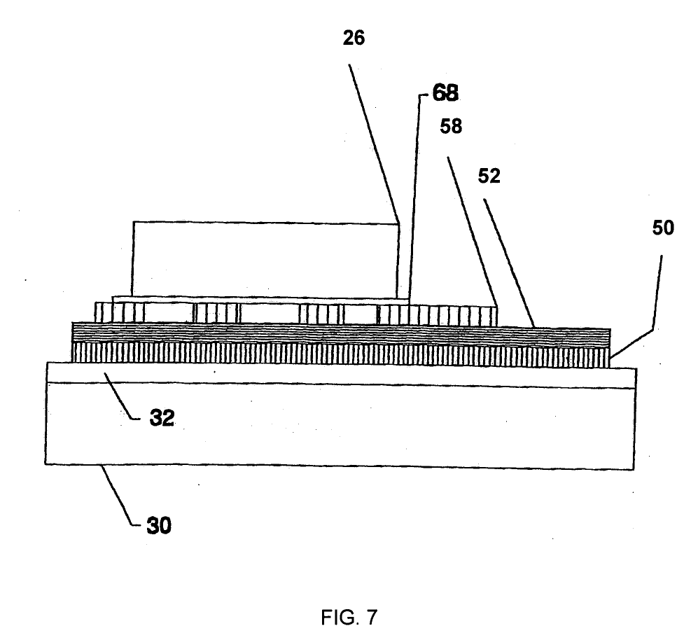

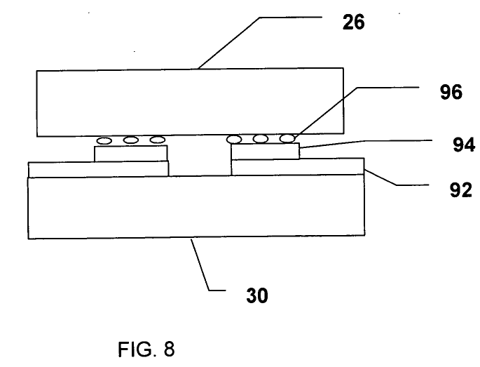

FIG. 7 shows a cross section of a transformer coupling embodiment. Substrate 30 has an antistat/adhesion layer 32 and printed thereon a first metal layer 70, and a dielectric cross over layer 72. A second metal layer 74 completes the circuit as shown in FIG. 5. In a preferred embodiment the first metal layer includes both the antenna loops and an additional transformer lop. The second metal layer includes one or more transformer loop which, when connected to the transformer loop on the first metal layer, forms a transformer coil have two or more loops. Adhesive layer 76 is placed on the second metal layer 74 and bonds chip 78 in close proximity to the transformer winding 58, 26. The thickness of the adhesive layer 76, typically about 5 microns or less, is small compared to the area (x-x, 60; and y-y, 62), of the primary transformer coil which is preferably of the order of about 250×250 microns or more. This assures efficient transfer of energy from the antenna to the chip and from the chip out to the antenna.

Encapsultating layer 28 protects the device from the environment and may also have a planarizing effect on the entire structure of the device.

In another embodiment, a substrate with an etched metal pattern is coated selectively with an adhesive by means of ink jet, ink pen, or toner like material. The material is a metal filled vinyl, epoxy or acrylic type resin. The conductive material is placed on the electrodes of the metal patterns. A semi-conducting die is placed, electrode side down on the conductive pads to make contact to the electrodes of the metal “antenna” pattern. Heating of the structure; substrate, adhesive, and semi-conducting die bonds the die and makes electrical contact between “antenna” terminals and die electrodes.

Substrate 90 with etched metal pattern 92, has imaged on its electrode pads, conductive adhesive dots 94. Over this die 96 is accurately placed so that the electrodes on die 96, not shown, align with pads 94. Heating to achieve re-flow or setting of adhesive 94 is applied as necessary.

Note: adhesive exists in which simple pressure activation is all that is required to achieve the bonding step. This is typical of the Eastman 910™ type of cyno-acrylic adhesives (i.e. the Crazy Glues). In this case the die would be pressed on to the adhesive dots to complete the bonding step, rather than a thermal re-flow step. In some applications thermal re-flow might be undesired as it causes an uncontrolled shrinkage of the substrate film (like PET where 1/2% is normally expected). This shrinkage negates any degree of overlay accuracy.

### EXAMPLES

The examples described below indicate how the individual constituents of the preferred compositions and the conditions for applying them function to provide the desired result. The examples will serve to further typify the nature of this invention, but should not be construed as a limitation in the scope thereof which scope is defined solely in the appended claims.

### Example I

A 25 micron thick PET film was coated with Saran® resin #F-276 (DOW) to a nominal thickness of 1 micron. Parmod Silver Toner E-43 (Parelec LLC, Rocky Hill, N.J.) was mixed to 1.5% by weight concentration to a conductivity of 5 pico siemens per cm. This toner was then imaged on a standard Electrox electrostatic printing plate (Dynachem #5038 dry film etch resist, exposed to a level of 250 mj/cm²). The silver toner image was transferred to the Saran coated PET film. The toner mage was dried at about 40° C.

Next a silicon chip thinned to 10 microns by means practiced by Virginia Semiconductor Inc. of Richmond, Va. was placed, active side down onto the silver toner image. The assembly of silicon chip on toner image on coated PET film was heated to 125° C. for two minutes. Good conductivity of the silver was achieved with excellent bonding of the chip to the silver.

### Example II

A three layer substrate was prepared using the same techniques of Example 1. A Saran coated PET film was imaged with Parmod toner and thermally cured into a useful conductive pattern. A dielectric “cross over” pattern of a Saran toner was printed and reflowed into a pin hole free layer. Note, the electrode pads of the conductive pattern of the first layer are left uncovered by the Saran cross-over layer. A second metal layer was printed on the Saran layer interconnecting the electrodes.

A portion of the pattern of the first layer and the pattern of the second metal layer were configured to form a coil pattern (“secondary winding”).

A dot of thermally or pressure activated adhesive was applied to the “secondary winding” region of the substrate and a silicon die with a “primary winding” contained on its surface was accurately placed on this adhesive. Bonding is completed by heat or pressure.

### Example III

A film substrate like 50 micron PET film coated with 500 Angstroms of pure aluminum metal was imaged in an Indigo NV Omnius Webstream printer. The Indigo toner was printed directly on the aluminum metal. The aluminum film printed with toner was then etched in a mild caustic bath removing the unprotected metal. The dried substrate was then stripped of the toner in the electrode areas with toluene.

A conductive adhesive (AbleStick#862B) was applied in small dots to the aluminum electrodes. A silicon die (Micro Chip Technologies of Phoenix Ariz., #MC-355) was placed, face down, on the conductive adhesive dot pattern; both boding the chip and making useful electrical to the substrate metal pattern.

### Example IV

The devices of Examples I, II and III were spray coated with Saran resin (#F-276, DOW) and then heated to cure the resin and form a protective coating on the entire device.

1. An RFID device comprising
a substrate;
an antenna means on said substrate, said antenna means being comprised of a metal toner printed in a pattern comprising at least one loop:
at least one silicon chip; and
a connection means for electrically connecting said antenna means and said silicon chip.

2. The RFID device of claim 1 wherein said connection means is comprised of an electrically conductive adhesive.

3. The RFID device of claim 1 wherein said connection means is comprised of:
a first coil means connected to said antenna means and a second coil means connected to said silicon chip.
wherein said first coil means and said second coil means are proximally located thereby facilitating electrical communication.

4. The RFID device of claim 3 wherein said first coil means is comprised of at least two loops wherein each of said at least two loops is separated by a layer of dielectric.

5. The RFID device of claim 4 wherein said first coil means has at least a first and a second loop each loop having two endpoints,
wherein a first loop is located on said substrate and
a second loop is located on a dielectric layer located above said first loop,
wherein one endpoint of said first loop is connected to said antenna means and the second endpoint of said first loop is connected to the first endpoint of said second loop through a hole in the dielectric layer and
wherein the second endpoint of said second loop is connected to said antenna means through an opening in the dielectric layer.

6. The RFID device of claim 3 wherein said first coil means is comprised of at least two loops wherein each of said at least two loops is separated by a layer of dielectric.

7. The RFID device of claim 3 wherein said second coil means is located on said silicon chip.

8. The RFID device of claim 1 wherein said antenna means is printed on said substrate.

9. The RFID device of claim 8 wherein printing is by electrostatic or inkjet printing methods.

10. The RFID device of claim 3 wherein said connection means is printed by electrostatic or inkjet printing methods.

11. The RFID device of claim 7 wherein said second coil means is printed by electrostatic or inkjet printing methods.

12. The RFID device of claim 1 further comprising a protective coating.

13. A process for the manufacture of RFID devices consisting of the following:
a. Electrostatic printing of a metal toner on a coated substrate, said printing comprising an antenna having at least one loop;
b. The drying of this metal toner image;
c. The mechanical placement of a silicon die on this dried, printed metal toner image;
d. The heating of this assembly to a suitable temperature causing a sintering of the metal toner particles together and a sintering of them to the electrode pads of the silicon die; and
e. The overcoat of the die/substrate with a protective coat.

14. The process of claim 13 in which the metal toner is made of silver.

15. The process of claim 13 in which the substrate is PET film or paper.

16. The process of claim 13 in which the substrate is coated with an adhesion/sintering layer that promotes both sintering of the metal particles and their adhesion to the substrates.

17. The process of claim 16 in which this coating is chosen from Saran™ resins of Dow Chemical.

18. A process for the manufacture of rf-ID devices in which:
a. metal toner is printed on a suitable substrate in a suitable pattern;
b. the pattern in the area of silicon chip mounting is configured into a single or multui-turn electro-magnetic coil;
c. this pattern is suitably processed into a conductive metal pattern;
d. the substrate is coated with a suitable adhesive layer;
e. a silicon die possessing an electromagnetic coil pattern of metal around its periphery is placed and aligned to the metal toner coil pattern of the substrate; and
f. the bonding reaction between die and adhesive coated substrate is completed by suitable means.

19. The process of claim 18 in which the die has been “thinned” to a value below 50 microns.

20. The process of claim 18 where the substrate thickness is less than 50 microns.

21. The process of claim 18 where the overall thickness of the final part is between 10 and 100 microns.
